(19) United States
(12) Patent Application Publication
(10) Pub. No.: US 2018/0273030 A1
(43) Pub. Date: Sep. 27, 2018

(54) Autonomous Vehicle having Pedestrian Protection Subsystem

(71) Applicants: Kevin Michael Weldon, Greensburg, PA (US); Kevin Patrick Weldon, Greensburg, PA (US)

(72) Inventors: Kevin Michael Weldon, Greensburg, PA (US); Kevin Patrick Weldon, Greensburg, PA (US)

(21) Appl. No.: 15/469,829

(22) Filed: Mar. 27, 2017

(51) Int. Cl. B60W 30/09; G05D 1/00; G05D 1/02; G08G 1/16; B60W 10/18; B60W 10/20; B60W 30/095

(52) U.S. Cl. CPC B60W 30/09; G05D 1/0088; G05D 1/0236; G05D 1/0257; G08G 1/166; B60W 10/18; B60W 2550/10; B60W 30/095; B60W 2710/18; B60W 2710/20; B60W 2720/106; B60W 2420/52; B60W 10/20

(57) ABSTRACT

An autonomous vehicle having a primary navigation system for controlling the direction of the vehicle as it travels across the landscape. In addition, the present invention has a pedestrian protection subsystem to supplement the navigation system using a real-time pedestrian protection subsystem. The pedestrian protection subsystem includes a processor, memory and a detector system for scanning the landscape to locate human breathing patterns. The detector system in one preferable embodiment may be a radar unit.

### FIELD OF THE INVENTION

The present disclosure relates to automotive vehicles, and more particularly to pedestrian safety systems for automotive vehicles. The present invention relates generally to the field of vehicle-based three-dimensional mapping of the space surrounding a vehicle. Including specifically sensing and identifying pedestrians and animals so that a collision may be averted.

### BACKGROUND OF THE INVENTION

Each year in the United States tens of thousands of citizens lose their lives on account of vehicle collisions. A large portion of these fatalities are attributed to vehicles colliding with stationary objects (e.g. telephone pole, tree . . . ) and colliding with other vehicles. A significant amount of human fatalities occurs when there is a vehicle collision between a vehicle and a pedestrian. In addition, fatalities often accompany vehicle damage whenever there is a collision with an animal such as a deer.

Early developments in the automobile industry focused on driver assistance systems that detected objects that were potential vehicle collision hazards. The driver assistance systems would provide a warning to the vehicle of a likely collision with an object near or in the pathway of a vehicle. Presently some vehicles are configured to operate in a practically autonomous manner and an autonomous manner in which the vehicle navigates through an environment with little or no input from a driver. These self-driving vehicles generally have multiple sensors that are configured to sense information about the environment. The vehicle may use the environment information to safely navigate the vehicle avoiding collisions with objects. For example, if the sensors sense that the vehicle is approaching an obstacle in the road, such as an orange cone, the vehicle navigates around the obstacle.

A surveying lidar sensor is a light detection and ranging sensor. It is an optical remote sensing module that can measure the distance to a target or objects in a landscape, by irradiating the target or landscape with light, using pulses from a laser, and measuring the time it takes photons to travel to said target or landscape and return after reflection to a receiver in the surveying lidar module unit. See US Patent Application Publication No. 2015/0192677 (Yu et al.) which discloses a surveying lidar sensing system for mapping the area surrounding a vehicle and is hereby incorporated by reference in its entirety. See also US Patent Application Publication No. 2016/0162742 (Rogan) an enhanced surveying lidar navigation system for classifying objects as either moving or stationary which is hereby incorporated by reference in its entirety.

The automobile industry has employed surveying lidar system specifically to identify pedestrians. A surveying lidar system in combination with audible alarms is employed to warn pedestrians of the oncoming vehicle, see U.S. Pat. No. 8,537,030 (Perkins) which is hereby incorporated by reference in its entirety.

Complicated algorithms and methods have been developed in the industry for greater accuracy in identifying objects as pedestrians. Large amounts of data from multiple data points are taken by present surveying lidar systems providing great detail of the navigated environment. The data is examined by a computer to determine if any subset of accumulated environment data may correspond to an upper body portion of a person.

There is a need to reduce the number of fatalities that arise because of vehicle collisions between pedestrians and animals

There is a need in the automobile industry for automated evaluation of surveyed lidar data of an environment to detect and identify the objects present in the environment and, more particularly, to identify if the objects are pedestrians and, velocity, and/or acceleration of the pedestrians. There is an even greater need for evaluating if the object is a pedestrian(s) in or near a roadway, to facilitate avoidance of pedestrian fatalities or severe injuries.

### SUMMARY OF THE INVENTION

An autonomous apparatus and method of controlling a vehicle to increase pedestrian protection comprises a high speed lidar system including a plurality of sensors and an ECU having a processor for evaluating surveyed landscape lidar data to identify objects in the landscape. The onboard ECU then determines if any lidar data subset detected as an object is a pedestrian by further evaluating any and all object lidar data subsets. The pedestrian determination is accomplished by comparing surveyed lidar data with predefined pedestrian threshold criteria. If a positive match is determined to exist at an acceptable probability level the vehicle may take evasive action to avoid a collision with the object now identified as a pedestrian should the pedestrian and vehicle be on a collision course. In addition, the present invention further comprises a pedestrian protection subsystem to supplement this pedestrian identification process by using a real-time pedestrian protection subsystem independently sensed data. The pedestrian protection subsystem includes a processor, memory and radar unit. The pedestrian protection subsystem processor in accordance with instructions provided from the memory analyzes radar signals for detecting pedestrians. The processor analyzes and compares received radar signals with predefined radar signal parameters stored in the non-volatile memory that are indicative of human breathing.

An autonomous apparatus and method of controlling a vehicle to increase pedestrian protection comprises a high speed lidar system including a plurality of sensors and an ECU having a processor for evaluating surveyed landscape lidar data to identify objects in the landscape. The onboard ECU then determines if any lidar data subset detected as an object is a pedestrian by further evaluating any and all object lidar data subsets. The pedestrian determination is accomplished by comparing surveyed lidar data with predefined pedestrian threshold criteria. If a positive match is determined to exist at an acceptable probability level the vehicle may take evasive action to avoid a collision with the object now identified as a pedestrian should the pedestrian and vehicle be on a collision course. In addition, the present invention further comprises a pedestrian protection subsystem to supplement this pedestrian identification process by using real-time pedestrian protection subsystem independently sensed data. The pedestrian protection subsystem includes a processor, memory and radar unit. The pedestrian protection subsystem processor in accordance with instructions provided from the memory analyzes radar signals. The processor analyzes and compares received radar signals with predefined radar signal parameters stored in the non-volatile memory that are indicative of human breathing. If the pedestrian protection subsystem detects human breathing, then the required probability level that an object's data matches the predefined pedestrian threshold criteria is modified to a lower probability level. If the object lidar data upon reevaluation is determined to fall within the range of the new revised probability level for predefined pedestrian threshold criteria, then the object data is considered to match the predefined pedestrian threshold criteria. Upon a positive match the vehicle may take evasive action to avoid a collision with the object now identified as a pedestrian should the pedestrian and vehicle be on a collision course.

An autonomous vehicle having a primary navigation means comprises a high speed lidar system including a plurality of sensors and an ECU having a processor for evaluating surveyed landscape lidar data to identify objects in the landscape. The onboard ECU then determines if any lidar data subset detected as an object is a pedestrian by further evaluating any and all object lidar data subsets. The pedestrian determination is accomplished by comparing surveyed lidar data with predefined pedestrian threshold criteria. If a positive match is determined to exist at an acceptable probability level the vehicle may take evasive action to avoid a collision with the object now identified as a pedestrian should the pedestrian and vehicle be on a collision course. In addition, the present invention further comprises a supplemental pedestrian protection subsystem to supplement this pedestrian identification process by using a real-time pedestrian protection subsystem independently sensed data. The pedestrian protection subsystem includes a processor, memory and radar unit. The pedestrian protection subsystem processor in accordance with instructions provided from the memory analyzes radar signals for detecting pedestrians. The processor analyzes and compares received radar signals with predefined radar signal parameters stored in the non-volatile memory that are indicative of human breathing. If the pedestrian protection subsystem detects human breathing, then the required probability level that an object's data matches the predefined pedestrian threshold criteria is modified to a lower probability level. If the object lidar data upon reevaluation is determined to fall within the range of the new revised probability level for predefined pedestrian threshold criteria, then the object data is considered to match the predefined pedestrian threshold criteria. Upon a positive match the vehicle may take evasive action to avoid a collision with the object now identified as a pedestrian should the pedestrian and vehicle be on a collision course.

An autonomous vehicle having a primary navigation means for controlling the direction of the vehicle as it travels across the landscape. In addition, the present invention further comprises a pedestrian protection subsystem to supplement the navigation means using a real-time pedestrian protection subsystem. The pedestrian protection subsystem includes a processor, memory and human breathing detecting means.

A radar for detecting breathing is employed to supplement a lidar autonomous control system on a vehicle for enhancing the protection of pedestrians. The radar identifies and locates humans in the landscape surrounding the vehicle. Computing means including an algorithm/software for providing processor instructions to analyze if the received radar signal data corresponds to predefined human breathing parameters. If human breathing is determined by the pedestrian protection subsystem a pedestrian alert is communicated to the lidar autonomous control system. Accordingly, a lower revised pedestrian notification threshold criteria is created whenever human breathing around the vehicle is being detected. Should any real-time analysis of an object lidar data subset exceed the revised pedestrian threshold criteria the vehicle ECU may initiate and take evasive action. The vehicle will react to alter the likelihood that an impact will occur by either accelerating, braking and/or steering in a different direction.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

FIG. 1 is an illustration of the autonomous vehicle of the present invention self-navigating down a road having typical surroundings with multiple objects that need to be taken into consideration for safe operation of the vehicle.

FIG. 2 is a schematic vehicle side view diagram of an exemplary implementation of the supplemental pedestrian protection subsystem of the present invention incorporated into the ECU of an autonomous vehicle.

FIG. 3. Is a simplified flowchart representing the present invention vehicle's autonomous method for avoiding collisions with pedestrian(s).

### DETAILED DESCRIPTION OF THE INVENTION

The following description is merely exemplary in nature and is in no way intended to limit the disclosure, its application, or uses. For purposes of clarity, the same reference numbers will be used in the drawings to identify similar elements.

The predefined threshold criteria for lidar data that the present invention electronic control unit uses to classify a lidar detected object as a pedestrian are hereinafter referred to as the pedestrian pattern standard.

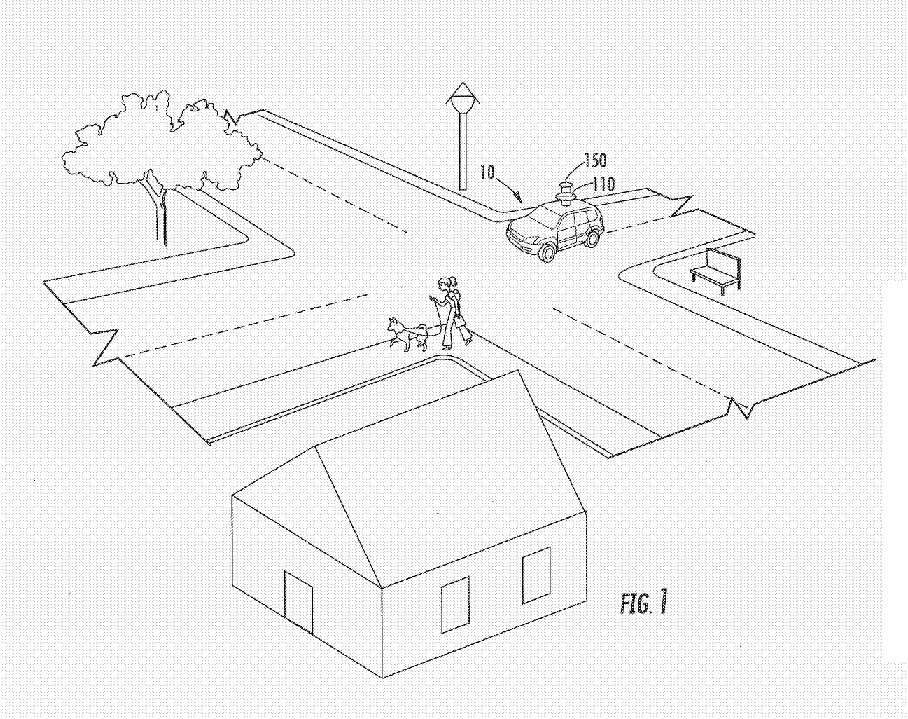

FIG. 1 illustrates an autonomous vehicle 10 of the present invention in a driving mode as it travels along a road. The vehicle is equipped with a primary navigation means for controlling the direction of the vehicle as it travels across the landscape. The landscape surrounding the vehicle includes a plurality of objects. One of the objects is a pedestrian walking her dog. The pedestrian is moving at a velocity that would intersect the direction of travel of the autonomous vehicle 10 resulting in a collision. The autonomous vehicle has a lidar unit 110 in direct communication with the vehicle electronic control unit (“ECU”) and a supplemental pedestrian protection subsystem that employs a radar unit 150 for providing independent data about the landscape surrounding the vehicle.

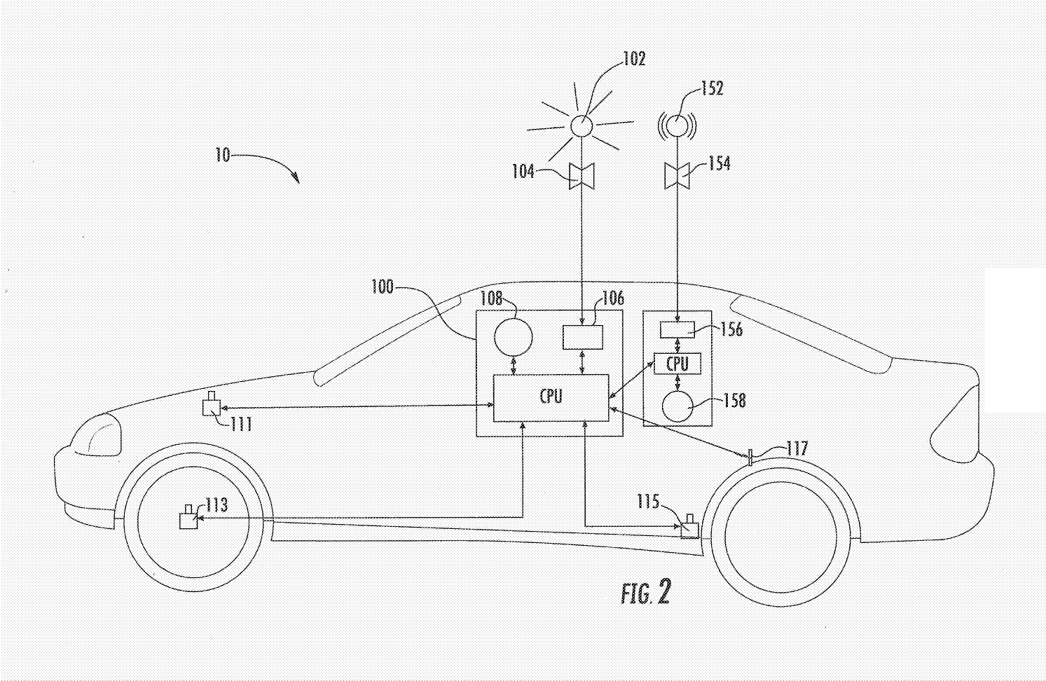

The lidar unit 110 includes lasers 102 and light detecting sensors 104, the lidar unit is in direct communication and directly controlled by the self-driving vehicle ECU. The ECU includes a central processor unit and memory. The memory includes both working memory 106 and non-volatile memory 108. The ECU 100 is also in communication with vehicle operation systems, including but not limited to the engine system, braking system and steering systems. In FIG. 2 the ECU 100 is shown being in communication with an engine control module 111, steering control module 113 and brake control module 115. The ECU is also in communication with vehicle sensors including but not limited to a speed sensor 117. The ECU may communicate with other vehicle systems and vehicle sensors such as, transmission control module, weather sensors and an accelerometer. One skilled in the art would be able to determine which other sensors and vehicle systems may provide useful information for assisting in the navigation of self-driving vehicles. The ECU continually monitors the vehicle systems and sensors in real time.

Lidar detects objects by projecting lasers 102 into the landscape and measuring the returns of reflected light off objects with sensors 104. The lidar unit 110 is mounted on top off the vehicle and includes one or more sensors 104 configured to receive information about the local landscape surrounding the vehicle. The lidar unit 110 may include one or more movable mounts that are automatically operable to adjust the orientation of one or more sensors 104 on the lidar unit. In one preferred embodiment, the scanning sensors and laser may be movably mounted on a rotating platform so as to obtain information from each direction around the vehicle 10. In another embodiment, a movable mount of for lidar a sensor may be made moveable in a scanning fashion within a particular range of angles and/or azimuths and other sensor(s) mounted to cover a different ranges of angles and/or azimuths. The lidar unit 110 may be mounted atop the roof of a car for instance, however other mounting locations are possible, the lidar unit may be mounted inside the front windshield of a vehicle. Preferably the lidar unit(s) 110 will be mounted on the vehicle at those locations where the lidar sensor system unit's performance in achieving driving safety is optimized.

The vehicle includes a supplemental pedestrian protection subsystem comprising a radar unit, processor and memory. The radar unit comprises a transmitter 152 and receiver 154. The transmitter(s) and antenna(s) are for generating and receiving electromagnetic radio waves respectively. The memory includes both working memory 156 and non-volatile memory 158. The supplemental pedestrian protection subsystem processor evaluates radar signals and communicates to the ECU information related to any pedestrians identified by the radar signals.

The supplemental pedestrian protection subsystem employs a radar unit scanning system for scanning at least the current direction of travel of the vehicle. Radar has been employed by both the military and industry for several decades in locating recognizing and calculating the velocity for objects of interest. More recently in the autonomous vehicle industry radars have been adopted for assisting in guiding a vehicle along a proper and safe course. These self-driving vehicles employ radar systems for detecting objects in the landscape surrounding the self-guided vehicle. See U.S. Pat. No. 9,423,498 (Brown) and U.S. Pat. No. 9,261,590 (Brown) which disclose radar system on self-driving vehicles are both herein incorporated by reference in their entirety.

The radar unit 150 may be mounted atop the roof of a car, for instance, however other mounting locations are possible, the radar unit alternatively may be mounted inside the front windshield of a vehicle. Other radar unit mounting locations for scanning the surrounding landscape may be employed. Preferably the radar unit 150 will be mounted on the vehicle at those locations where the lidar sensor system unit's performance in achieving driving safety is optimized.

In response to the received lidar data the ECU is programmed to send command signals to actuators including but not limited to braking actuators, the accelerator actuator and the steering actuator to navigate the vehicle and perform other vehicle operations. Other controlled vehicle operations may include sounding a horn, flashing a rear emergency lights and pre-tensioning the seat belts. Upon receiving data from the lidar unit 110, the vehicle's ECU may be programmed to accumulate data points together in subsets for instance for storing, evaluation and/or analysis. The ECU may create a 3D point cloud map based on the range data and/or configure the raw data into some other useful format. The ECU may analyze the range data within the 3D point cloud map using a variety of techniques, which may include the use of software and/or algorithms stored in non-volatile memory 108.

In one preferred embodiment of the invention the lidar data is processed by the ECU and temporarily stored in a lidar 3D point cloud map. Each data point captured by vehicle lidar sensors may correspond or be related to parameters associated with objects and/or terrain. A lidar data point may provide the ECU with information regarding terrain or an object's position, size, and/or other parameters. The raw lidar data is analyzed and processed by the ECU to identify objects in the landscape surrounding the vehicle. As seen in FIG. 1 there are multiple objects in the landscape surrounding the vehicle including a pine tree, lamppost, bench, house, dog and pedestrian. These multiple objects are each grouped into subsets of lidar data and located in their proper relative positions with respect to the vehicle 10 in a 3D point cloud map. The ECU includes software for tracking objects so that objects may also be classified as moving or stationary objects. Autonomous vehicle systems for laser scanning surrounding landscape, particularly objects located in the direction of travel of the vehicle, are well-known in the art, see US Patent Application Publications 2015/0219764, (Lipson) published Aug. 6, 2015, and 2015/0192677 (Yu et al), published Jul. 9, 2015 which are both herein incorporated by reference in their entirety. Also, see U.S. Pat. No. 6,956,469 (Hirvonen et al.) patented Oct. 18, 2005 and U.S. Pat. No. 6,035,053 (Yoshioka et al) patented Mar. 7, 2000 which are both herein incorporated by reference in their entirety.

The analysis of lidar data may include the use of software and/or algorithms to identify collected raw lidar data that for instance corresponds to parameters of a predefined pedestrian pattern standard. Once first identifying raw lidar data as being an object of some kind the ECU further analyzes each of the object subsets of lidar data to determine if any of the objects are pedestrians. The ECU may analyze lidar data object subsets to determine if the data potentially corresponds with predefined parameters indicative of an outline of an upper-body region of a pedestrian including a head region, chest region, and/or other portions of a pedestrian and calculated predefined spatial distances between these regions. These parameters may comprise spatial distances between upper regions (e.g. head and chest, shoulders and arm) of typical pedestrians existing in the real world. The ECU is programmed to ignore those processed object lidar data subsets that do not fall within a predefined range of typical pedestrian head-chest spatial distance parameters. Inclusive and integrated into the predefined lidar pedestrian pattern standard parameters is an acceptable probability level. The ECU may store the processed data and/or raw data within a lidar 3D point cloud map using a variety of techniques.

Recognizing a pedestrian amongst received raw lidar data may include the application of different processes, algorithms, measurements, and/or software. A computing means may utilize software and/or algorithms to determine if the identified regions in data correspond to pedestrians. The software and/or algorithms may utilize the various spatial distance measurements that may be made based on the detected potential regions within data that may correspond to a pedestrian. Other confirmation processes may be utilized by the vehicle's computing system as well. See U.S. Pat. No. 9,336,436 (Dowdall) and US Patent application 2011/0255741 (Jung et al.) which disclose self-driving vehicles employing sophisticated methods of identifying pedestrians, both are hereby incorporated by reference in their entirety.

The present invention's ECU computer includes a buffer for temporarily storing lidar data that does not quite fall within the predefined parameters of a pedestrian pattern standard. Such temporality stored data may be further evaluated by the ECU as it may still be determined that the lidar data may be indicative of a pedestrian being present. For a given percentage probability level, the phrase probability level as used hereinafter shall mean that for predefined intervals of preselected relevant parameters of a pedestrian pattern standard there is that percent probability that if a subset of lidar data falls within these predefined intervals it is a pedestrian. For example, a 99% probability level would mean that for that particular subset of object lidar data there is 99% likelihood that the object is a pedestrian. The buffer may store lidar data that although does not fall within the scope of a 99% probability level in matching the predefined pedestrian pattern standard it may potentially fall within a predefined lower probability level and awaits possible further evaluation contingent on the supplemental subsystem detecting a pedestrian. For instance, a probability level of 95% may be integrally adopted into the predefined pedestrian pattern standard parameters and the ECU may then next apply the predefined lower 75% probability level pedestrian pattern standard parameters for evaluation and comparison. Only upon detection of a pedestrian with the supplemental subsystem does the ECU processor again evaluate and compare the same lidar object data subset(s) with the revised pedestrian pattern standard. In a preferred embodiment, a probability level of 95% may be integrally employed into the predefined pedestrian pattern standard and the predefined revised pedestrian pattern standard is set at a 50% probability level pedestrian pattern standard. In a preferred embodiment, a probability level of 80% may be integrally employed into the predefined pedestrian pattern standard and the predefined revised pedestrian pattern standard is set at a 50% probability level pedestrian pattern standard. In a preferred embodiment, a probability level of 75% may be integrally employed into the predefined pedestrian pattern standard and the predefined revised pedestrian pattern standard is set at a 40% probability level pedestrian pattern standard. In another preferred embodiment, a probability level of 80% may be integrally employed into the predefined pedestrian pattern standard and the predefined revised pedestrian pattern standard is set at a 30% probability level pedestrian pattern standard. In yet another preferred embodiment a probability level of 60% may be integrally employed into the predefined pedestrian pattern standard and the predefined revised pedestrian pattern standard is set at a 25% probability level pedestrian pattern standard.

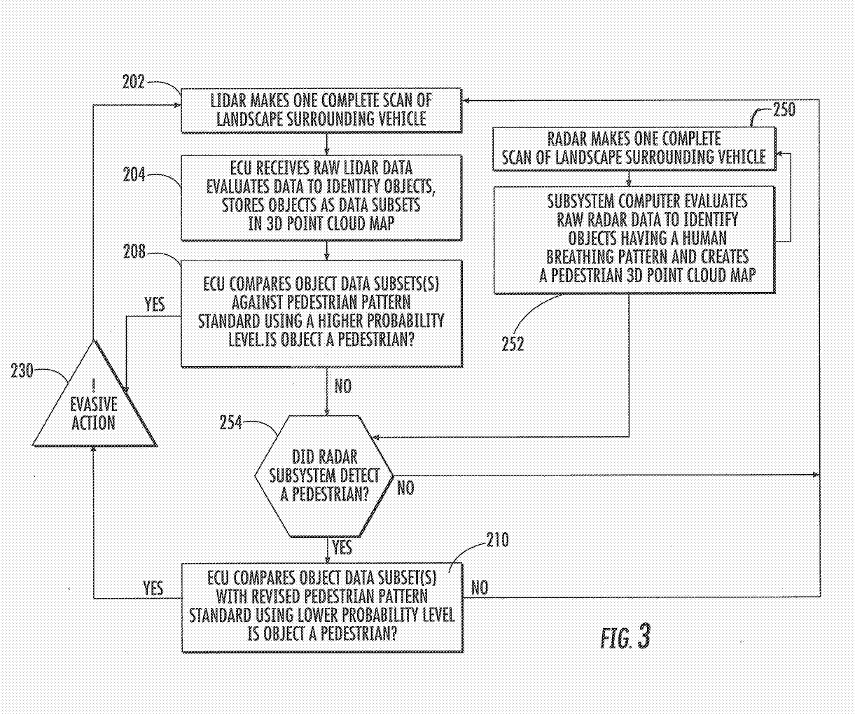

The flowchart in FIG. 3 shows functionality and operation of a preferred embodiment of the present invention. Each block may represent a component of an ECU or a portion of program code/algorithm, which includes one or more instructions executable by a computer microprocessor to perform steps for controlling the vehicle in its environment. The program code may be stored on any type of computer readable medium, for example, such as a storage device including a disk, solid state memory or hard drive.

At block 202 in FIG. 3, the first step of the present invention includes continually scanning at a high-speed rate lidar range data points corresponding to the landscape surrounding the vehicle. One complete scan would be the maximum number of measurements of the surrounding landscape that the lidar's laser unit could illuminate and detect for instance when the vehicle is stationary and everything in the landscape is stationary. In one preferred embodiment one complete scan would be the number of measurements made by the laser unit during one 360° scan of the landscape surrounding the vehicle. The vehicle lidar sensors capture data corresponding to the landscape including objects. At block 204 an ECU computing device receives the raw lidar data and evaluates the data to locate and pinpoint objects in the surrounding landscape. For instance, in block 204 the continually gathered raw lidar data are analyzed in accordance with software instructions provided to the ECU processor. Lidar data recognized by the ECU as being representative of an object are each organized into subsets of data at step 204. The vehicle's ECU may analyze the lidar data to gather and briefly store it in practically real time in a point cloud map including storing each object identified in the landscape as its own unique data subset. In a preferred embodiment the vehicle ECU captures and creates a map that encompassing the entire 360° about the vehicle from street level on up to at least 20 feet high above the street. The ECU includes navigation software which autonomously controls the navigation of the vehicle so as to avoid collision with the sensed objects.

In addition to identifying some lidar data as objects and locating them in a point cloud map at block 204 the object subsets of data for each object are further analyzed by the ECU processor as represented by block 208. At block 208 the ECU processor evaluates each object subset of data to classify an object as either a pedestrian or non-pedestrian. Software stored in the ECU non-volatile memory provides instructions to the ECU processor for evaluating each object data subset. If a subset of lidar data meets the predefined pedestrian pattern standard parameters and the vehicle and pedestrian are currently on a collision course the ECU would command the vehicle to take evasive action 230. The ECU computer processor classifies pedestrian evasive action control commands as highest priority relative to any pending non-human object evasive action vehicle control commands. and the vehicle would be so navigated to first and foremost avoid collision with pedestrians over collision with objects.

At block 250 in FIG. 3 real time radar signals from complete scan sets of the surroundings are continually collected by the supplemental pedestrian protection subsystem as the radar scans the surrounding landscape during vehicle operation. Next in block 252 the raw radar signals are evaluated by a subsystem processor to locate and pinpoint any and all objects exhibiting a human breathing pattern and identifies the objects as pedestrians. The subsystem computer processor next creates a pedestrian 3D point cloud map locating the position of any pedestrian. Radar signals can be used in searching for people or animals by detecting and identifying theft breathing patterns. See US Patent Application Publication No. 2015/0369911 (Mabrouk et al) which is herein incorporated by reference in its entirety.

If no human breath is detected in the vicinity of the vehicle, then the supplemental pedestrian protection subsystem continues to gather 250 and analyze 252 real time radar data searching for possible pedestrians in the landscape surrounding the vehicle. In block 254 whenever it is determined that some radar data matches parameters indicative of human breathing pattern then there is an increased likelihood that a lidar detected object may be a pedestrian. Accordingly, this increased possibility of a pedestrian must be taken into consideration during navigation of the vehicle. Therefor the acceptable probability level for determining object data subsets as matching with the lidar predefined pedestrian pattern standard is adjusted lower (e.g. 70%) to possibly include object data subset(s) that did not quite qualify at the original higher probability level (e.g. 95%). The same object lidar data subset(s) is then next evaluated and compared with these lower revised predefined pedestrian pattern standard parameters as seen in block 210.

It should be noted that the pedestrian pattern standard must be continually revised to the lower predefined probability level pedestrian protection standard in real time. In the default the predefined higher probability level pedestrian pattern standard is used for comparison and classification of an object as a pedestrian unless human breathing is detected by the pedestrian protection subsystem. The “currently revised” predefined pedestrian pattern standard is or remains adjusted lower only so long as human breathing is detected by the supplemental pedestrian protection subsystem.

If an object's subset of data falls within the parameters for the pedestrian pattern standard at block 208 or the parameters of a revised lower pedestrian pattern standard at block 210 and the tracked pedestrian's velocity and tracked vehicles velocity place them on a collision course the pedestrian is likely to be severely injured by the vehicle. Accordingly, the ECU will direct the vehicle to take evasive action as shown in the flowchart at block 230. The ECU for instance will control the vehicle to accelerate, brake or stop to avoid the pedestrian(s).

As time progresses real time analysis of landscape lidar data continues to be evaluated and assessed along with real time radar signals in a constant loop during vehicle operation. It is contemplated that the location of an object(s) identified with the lidar system will be pinpointed in a 3D point cloud map as a data subset and the human breathing determined by the radar subsystem will be pinpointed in the same 30 point cloud map. Accordingly, whenever there is an overlap in the 3D point cloud map between a human breathing radar signal and a lidar detected object data subset the lidar pedestrian pattern standard probability level used by the ECU for evaluation of an object data subset is lowered.

Based upon the data input from the Lidar sensors and pedestrian protection subsystem as mentioned above the ECU determines if an object is a pedestrian and the ECU also determines if an impact with the pedestrian is likely to occur. This determination is based upon the position and velocity of the pedestrian and the position and velocity of the vehicle. Further the ECU may determine that a collision course does not exist but may control the direction of the vehicle based on a preference for maintaining a predefined safe distance from pedestrians.

In some instances, the pedestrian pattern standard is not met but the lidar has however detected an “object” that is not a pedestrian at the same corresponding location where a human breathing pattern has been pinpointed by radar signals. In such instances, it is likely that detection of a pedestrian by lidar is out of the line of sight and is being obstructed by another “object”. The other object data subset perhaps may be a wall or tree that blocks the laser from contacting and detecting the surface profile of the pedestrian. It is contemplated that in an alternative embodiment that should a non-pedestrian object pinpointed in a 3D point cloud map as a data subset and a human breathing pattern recognized by the radar subsystem pinpointed in the same 3D point cloud map overlap that the vehicle may take evasive maneuvers.

In the alternative, the vehicle may utilize multiple sensing systems to make an initial determination of a pedestrian. For example, a vehicle's computing control system may analyze images captured by a vehicle's camera system in addition to Lidar data to determine the position of a pedestrian relative to the vehicle and further comprise a supplemental pedestrian protection system employing recognition of human breathing with radar. It should be appreciated by one of ordinary skill in the art that the present invention is not intended to be necessarily limited to supplementing only autonomous vehicles using lidar systems with a pedestrian protection subsystem. It is contemplated that such a subsystem may alternatively supplement any of the standalone environment sensing devices employed by autonomous vehicles or a combination thereof including cameras, range finders and acoustic sensors. See self-driving vehicle camera sensor systems in U.S. Pat. No. 7,418,112 (Ogasawara) and U.S. Pat. No. 8,164,432 (Broggi et al.) which are both herein incorporated by reference in their entirety.

It is further contemplated that other breathing sensing means than radar may be employed for sensing a human breathing including lidar. See lidar methods for monitoring human breathing in US Patent Application Publication No. 2009/0048500 (Corn) and U.S. Pat. No. 6,062,216 (Corn) which are herein incorporated by reference in their entirety.

In addition to identifying pedestrian breathing with using the radar in the subsystem, that the subsystem may be programmed to identify animal breathing harmonics and rates which differ from humans such as dogs and deer. See U.S. Pat. No. 9,336,436 (Dowdall).

While certain novel features of this invention have been shown and described, it is not intended to be limited to the details above, since it will be understood that various omissions, modifications, substitutions and changes in the forms and details of the coating can be made by those skilled in the art without departing in any way from the spirit of the present invention.

The invention claimed is:

1. An autonomous vehicle comprising:
a primary navigation means for controlling the direction of said vehicle as said vehicle travels across the landscape, and
a pedestrian protection subsystem for supplementing said primary navigation means, wherein said pedestrian protection subsystem includes a processor, memory and human breathing detecting means.

2. An autonomous vehicle according to claim 1, wherein said human breathing detecting means comprises:
a radar unit.

3. An autonomous vehicle according to claim 2, wherein said pedestrian protection subsystem is programmed to analyze and compare radar signals with predefined radar signal parameters stored in said memory that are indicative of a human breathing pattern.

4. An autonomous vehicle according to claim 2, wherein said pedestrian protection subsystem is programmed to analyze and compare data detected by said human breathing detecting means with predefined parameters stored in said memory that are indicative of a human breathing pattern.

5. An autonomous vehicle comprising:
a primary navigation means having an electronic control unit in communication with a lidar unit, vehicle performance sensors and vehicle actuators,
said lidar unit scans the surrounding landscape collecting raw surveyed raw lidar data,
said electronic control unit analyzes and compares said raw lidar data with an original pedestrian pattern standard to makes a determination if said raw lidar data corresponds to a pedestrian,
a pedestrian protection subsystem for supplementing said navigation means, wherein said pedestrian protection subsystem, said pedestrian protection subsystem includes a computer processor, memory and human breathing detecting means.

6. An autonomous vehicle according to claim 5, wherein
said human breathing detecting means is a radar unit, radar signals from said radar unit are analyzed by said computer processor to determine if said radar signals match a predefined human breathing pattern,
said electronic control unit upon receipt of human breathing notification further analyzes and compares said raw lidar data with a revised pedestrian pattern standard to make a determination if said raw lidar data correspond to a pedestrian.

7. An autonomous vehicle according to claim 6, wherein said revised pedestrian pattern standard for evaluating said lidar data has a lower probability level of corresponding to an actual pedestrian than said original pedestrian pattern standard.

8. An autonomous vehicle according to claim 7, wherein said original pedestrian pattern standard has a 95% probability level.

9. An autonomous vehicle according to claim 8, wherein said revised pedestrian pattern standard has a 75% probability level.

10. An autonomous vehicle according to claim 8, wherein said revised pedestrian pattern standard has a 50% probability level.

11. An autonomous vehicle according to claim 7, wherein said original pedestrian pattern standard has a 80% probability level.

12. An autonomous vehicle according to claim 11 wherein said revised pedestrian pattern standard has a 50% probability level.

13. An autonomous vehicle according to claim 7, wherein said original pedestrian pattern standard has a 60% probability level.

14. An autonomous vehicle according to claim 13, wherein said revised pedestrian pattern standard has a 25% probability level.

15. An autonomous vehicle according to claim 5, wherein said electronic control unit upon making a determination that surveyed lidar data corresponds to said original pedestrian pattern standard acknowledges that there is an actual pedestrian and controls said vehicle to take evasive action to avoid a collision with said actual pedestrian.

16. An autonomous vehicle according to claim 6, wherein said electronic control unit upon making a determination that surveyed lidar data corresponds to said original pedestrian pattern standard acknowledges that there is an actual pedestrian and controls said vehicle to take evasive action to avoid a collision with said actual pedestrian.

17. An autonomous vehicle comprising:
a primary navigation means having an electronic control unit in communication with a lidar unit, vehicle sensors and vehicle actuators,
said lidar unit scans the surrounding landscape collecting raw surveyed lidar data,
said electronic control unit analyzes and compares said raw lidar data with an original pedestrian pattern standard to makes a determination if said raw lidar data corresponds to a pedestrian,
a pedestrian protection subsystem for supplementing said navigation means, wherein said pedestrian protection subsystem includes a processor, memory and human breathing detecting means,
said human breathing detecting means is a radar unit, radar signals from said radar unit are analyzed by said computer processor to determine if said radar signals match a predefined human breathing pattern,
said electronic control unit upon receipt of human breathing notification further analyzes and compares said raw lidar data with a revised pedestrian pattern standard to makes a determination if said raw lidar data correspond to a pedestrian,
said electronic control unit upon making a determination that surveyed lidar data corresponds to said original pedestrian pattern standard acknowledges or said revised pedestrian pattern standard that there is an actual pedestrian and controls said vehicle to take evasive action to avoid a collision with said actual pedestrian.

18. An autonomous vehicle according to claim 17, wherein said revised pedestrian pattern standard for evaluating said lidar data has a lower probability level of corresponding to an actual pedestrian than said original pedestrian pattern standard.

19. An autonomous vehicle according to claim 18, wherein said pedestrian protection subsystem memory includes software instruction for said computer processor to analyze said radar signals to determine if said radar signals match a predefined breathing pattern for a dog or deer.

20. An autonomous vehicle according to claim 19, wherein said radar unit can detect human breathing patterns out of the line of sight and determines that a non-pedestrian lidar object data subset possibly overlaps said breathing pattern controls said autonomous vehicle to take evasive action to avoid a collision with said actual pedestrian.
